(19) United States
(12) Patent Application Publication
(10) Pub. No.: US 2021/0076828 A1
(43) Pub. Date: Mar. 18, 2021

(54) TRAVEL APPARATUS AND METHOD

(71) Applicant: Jonathan Joerg, Dover, OH (US)

(72) Inventor: Jonathan Joerg, Dover, OH (US)

(21) Appl. No.: 17/016,865

(22) Filed: Sep. 10, 2020

Related U.S. Application Data
(60) Provisional application No. 62/899,334, filed on Sep. 12, 2019.

(51) Int. Cl. A47C 7/38; A47G 9/02; A47G 9/10; A47G 9/04; B64D 11/06; B60N 2/879; B60N 2/24; B61D 31/00

(52) U.S. Cl. CPC A47C 7/383; A47G 9/0223; A47G 9/1045; B61D 31/00; B64D 11/0647; B60N 2/879; B60N 2/242; A47G 9/04

(57) ABSTRACT

A travel apparatus which includes a pillow with a fastener and a blanket with a fastener, wherein the blanket is attachable to the pillow, the blanket is attached to the pillow by the fasteners, and the travel apparatus is configured such that when a person sits in a seat and the back of the person's head is resting against the pillow, the blanket is supported by the pillow, and said blanket does not cover the face of the person sitting in the seat. Also a method comprising securing a blanket to a pillow such that when a person sits in the seat the back of the person's head is resting against the pillow, the blanket is supported by the pillow, and the blanket does not cover the face of the person sitting in the seat.

### CROSS-REFERENCE TO RELATED APPLICATIONS

This application claims the benefit of and priority to U.S. Provisional Application No. 62/899334, filed Sep. 12, 2019, the contents of which are hereby incorporated by reference in their entirety.

### BACKGROUND

### 1. Field

The present disclosure relates to a travel apparatus comprising a blanket and a pillow. The travel apparatus comprises a pillow with a fastener and a blanket with a fastener, wherein the blanket is attachable to the pillow, wherein the blanket is attached to the pillow by the fasteners, and the travel apparatus is configured such that when a person sits in a seat and the back of the person's head is resting against said pillow, the blanket is supported by the pillow, and the blanket does not cover the face of the person sitting in the seat. In certain embodiments, the travel apparatus can be used as a travel pillow and blanket and a person while sitting can simultaneously utilize the pillow for head support and be substantially covered by the blanket without the person using his or her arms to support either the pillow or the blanket, and the pillow is substantially held in place horizontally by at least one of the fasteners securing the pillow to the blanket. Also disclosed is a method comprising securing a blanket to a pillow such that when a person sits in the seat the back of the person's head is resting against the pillow, the blanket is supported by the pillow, and the blanket does not cover the face of the person sitting in the seat.

### 2. Description of Related Prior Art

Travelers, including on airlines, buses, cars, and trains, commonly attempt to rest while traveling. In so doing, travelers commonly wish to comfortably rest their head and attempt to stay warm, sometimes through use of a pillow and a blanket. Obtaining satisfactory comfort levels can be difficult given the relatively small spaces available for passengers on many forms of transportation. Additionally, bringing one's own pillow and blanket is not always desirable, as such must be transported by the traveler, who often is transporting other items such as, for example, luggage, carry-ons, entertainment, and/or food. Travelers also often do not wish to utilize pillows and blankets provided by a common carrier, for example, due to questions of cleanliness and/or hygiene in relation to the pillows and blankets. Also, when using a traditional pillow and blanket, when sitting in a seat the blanket must often be kept in place on the traveler's body by use of the traveler's arms, and often will fall if the traveler does not hold it in place with one or both of his or her arms or hands, and the pillow often moves substantially horizontally behind the person's head.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

According to the features disclosed herein, a travel apparatus comprising a blanket and a pillow. The travel apparatus comprises a pillow with a fastener and a blanket with a fastener, wherein the blanket is attachable to the pillow, the blanket is attached to the pillow by the fasteners, and the travel apparatus is configured such that when a person sits in the seat and the back of the person's head is resting against the pillow, the blanket is supported by the pillow, and the blanket does not cover the face of the person sitting in the seat.

In another embodiment, certain fasteners attaching the pillow to the blanket are located beside one side of the person's neck and other fasteners attaching the pillow to the blanket are located beside the opposite side of the person's neck.

In another embodiment, the travel apparatus is further configured such that horizontal movement of the pillow is restricted by at least one of the fasteners.

In another embodiment, the travel apparatus is configured such that no additional support is needed to hold the blanket substantially vertically in place.

In another embodiment, the travel apparatus is configured such that the person does not need to use his hands or arms to support the pillow or blanket.

In another embodiment, the travel apparatus is configured such that, relative to the blanket's area, the blanket substantially covers the front of the person's body below the person's chin.

In another embodiment, the travel apparatus is configured such that the pillow is substantially held in place horizontally without the use of the person's hands or arms.

In another embodiment, the fastener of the pillow is selected from a group consisting of Velcro, a button, and a snap.

In another embodiment, the pillow further comprises a storage compartment configured to store said blanket.

In another embodiment, the storage compartment comprises a pocket attached to the exterior of the pillow.

In another embodiment, the pillow is horseshoe-shaped, such as a “neck pillow.”

In another embodiment, the seat is a seat of an airplane, train, car, or bus.

In another embodiment, the seat is in a substantially upright position.

In another embodiment, further comprises fasteners configured to secure the pillow to a headrest.

Also disclosed herein is a method comprising securing a blanket to a pillow such that when a person sits in the seat the back of the person's head is resting against the pillow, the blanket is supported by the pillow, and the blanket does not cover the face of the person sitting in the seat.

In another embodiment of the method, the blanket is secured to the pillow by fasteners located beside one side of the person's neck and fasteners located beside the opposite side of the person's neck.

In another embodiment of the method, the pillow is substantially secured in place horizontally by at least one of the fasteners securing the blanket to the pillow.

In another embodiment of the method, the seat is in a substantially upright position.

In another embodiment of the method, the blanket is secured in a substantially parallel position relative to the seat's back and the person does not need to use the person's hands or arms to secure the blanket in such substantially parallel position relative to the seat's back.

In another embodiment of the method, the seat is a seat of an airplane, train, car, or bus.

### BRIEF DESCRIPTION OF THE DRAWINGS

The detailed description set forth below references the following drawings:

FIG. 1 discloses a side-view of an exemplary pillow of an exemplary travel apparatus.

FIG. 2 discloses a front-view of an exemplary pillow of an exemplary travel apparatus.

FIG. 3 discloses a back-view of an exemplary pillow of an exemplary travel apparatus.

FIG. 4 discloses a perspective-view of an exemplary pillow of an exemplary travel apparatus, with the pillow including a storage compartment.

FIG. 5 discloses a front view of an exemplary travel apparatus.

FIG. 6 discloses an exemplary fastener of an exemplary travel apparatus.

FIG. 7 discloses an exemplary combination pillow and blanket in use by an exemplary person.

### DETAILED DESCRIPTION

The present disclosure, as demonstrated by the example embodiments described below, includes a travel apparatus comprising a blanket and a pillow. The travel apparatus comprises a pillow with a fastener and a blanket with a fastener, wherein the blanket is attachable to the pillow, and the pillow further comprises fasteners, wherein the blanket is attached to the pillow by the fasteners and the travel apparatus is configured such that when a person sits in the seat and a back of the person's head is resting against the pillow, the blanket is supported by the pillow, and the blanket does not cover the face of the person sitting in the seat.

The disclosure also includes an exemplary travel apparatus wherein certain fasteners attaching the pillow to the blanket are located beside one side of the person's neck and other fasteners attaching the pillow to the blanket are located beside the opposite side of the person's neck.

The disclosure also includes an exemplary travel apparatus further configured such that horizontal movement of the pillow is restricted by at least one of the fasteners.

The disclosure herein also includes an exemplary travel apparatus configured such that no additional support is needed to hold the blanket substantially vertically in place.

The disclosure herein also includes an exemplary travel apparatus configured such that the person does not need to use his or her hands or arms to support the pillow or blanket.

The disclosure herein also includes an exemplary travel apparatus configured such that, relative to the blanket's area, the blanket substantially covers the front of the person's body below the person's chin.

The disclosure herein also includes an exemplary travel apparatus configured such that the pillow is substantially held in place horizontally without the use of the person's hands or arms.

The disclosure herein also includes an exemplary travel apparatus wherein the fastener of the pillow is selected from a group consisting of Velcro, a button, and a snap.

The disclosure herein also includes an exemplary travel apparatus wherein the pillow further comprises a storage compartment configured to store the blanket.

The disclosure herein also includes an exemplary travel apparatus wherein the storage compartment comprises a pocket attached to an exterior of the pillow.

The disclosure herein also includes an exemplary travel apparatus wherein the pillow is horseshoe-shaped, such as a “neck pillow.”

The disclosure herein also includes an exemplary travel apparatus wherein the seat is a seat of an airplane, train, or bus.

The disclosure herein also includes the travel apparatus wherein the pillow further comprises fasteners configured to secure the pillow to a headrest.

The disclosure herein also includes a method comprising securing a blanket to the pillow such that when a person sits in the seat the back of the person's head is resting against the pillow, the blanket is supported by the pillow, and the blanket does not cover the face of the person sitting in the seat.

The disclosure herein also includes another embodiment of the method wherein the blanket is secured to the pillow by fasteners located beside one side of the person's neck and fasteners located beside the opposite side of the person's neck.

The disclosure herein also includes another embodiment of the method wherein the pillow is substantially secured in place horizontally by at least one of the fasteners securing the blanket to the pillow.

The disclosure herein also includes another embodiment of the method wherein the seat is in a substantially upright position.

The disclosure herein also includes another embodiment of the method wherein the blanket is secured in a substantially parallel position relative to the seat's back and the person does not need to use the person's hands or arms to secure the blanket in such substantially parallel position relative to the seat's back.

The disclosure herein also includes another embodiment of the method wherein the seat is a seat of an airplane, train, car, or bus.

The disclosure herein also includes an exemplary method comprising securing a pillow to a headrest of a seat.

A benefit of at least one of the exemplary embodiment(s) disclosed herein is that the travel apparatus may be used by travelers, as such embodiment is lightweight and relatively compact. Further, at least one exemplary embodiment of the travel apparatus includes a storage compartment of the pillow in which the blanket may be stored, thereby easing transportation of the travel apparatus.

A further benefit of at least one of the exemplary embodiment(s) disclosed herein is that the exemplary travel apparatus may be used while a traveler is sitting such that the traveler can sit on a seat, relax his or her head against the pillow, and have the pillow held substantially horizontally in place and the blanket supported by the pillow such that, although the traveler does not hold the pillow or blanket in place with his or her arms, the blanket is held relatively upright by the pillow and does not cover the traveler's face.

Referring now to the drawings and figures, FIG. 1 discloses a side-view of an exemplary pillow 1 of an exemplary travel apparatus. Fastener 2 of pillow 1 is attached to the bottom of pillow 1. An exemplary fastener 2 is attached to the back of pillow 1. The exterior of exemplary pillow 1 may be comprised of fabric (such as, for example, cotton or polyester), leather, fur, nylon, or other suitable material. The interior of exemplary pillow 1 may be comprised of foam, polyester, feathers, or any other suitable material.

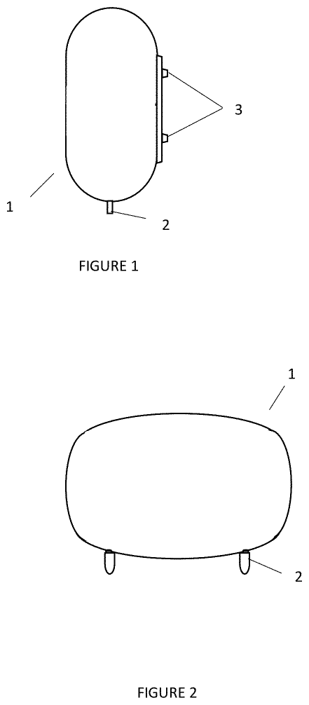

As shown in FIG. 2, which depicts a front-view of an exemplary pillow 1 of an exemplary travel apparatus, exemplary fasteners 2 of pillow 1 may be spaced relatively-widely apart from one another along the longitudinal axis of pillow 1. Such placement may be such that the distance between fasteners 2 is wider than the width of the neck of a person resting his or her head against pillow 1. Exemplary fasteners 2 may include Velcro, a button, a snap, straps, sewed fabric, or other suitable fastener.

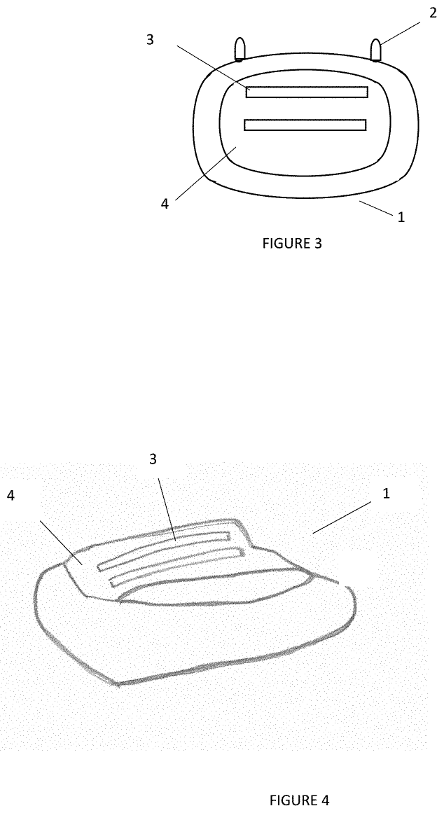

As shown in FIG. 3, which depicts a back-view of an exemplary pillow 1 of an exemplary travel apparatus, one or more exemplary fasteners (herein described as straps 3) may be attached to the back of exemplary pillow 1. Exemplary straps 3 may be configured such that they may be used to attach exemplary pillow 1 to a head rest of a seat and may be elastic straps or other suitable types of fasteners.

As shown in FIG. 4, which depicts a perspective-view of an exemplary pillow 1 of an exemplary travel apparatus, exemplary pillow 1 includes exemplary storage compartment 4. Exemplary storage compartment 4 may comprise a pocket attached to the back of exemplary pillow 1. Exemplary storage compartment 4 may be configured such that it can be opened and closed, including through the use of Velcro, zippers, snaps, buttons, other fasteners, or an envelope-style closure pocket. Exemplary storage compartment 4 may be configured such that a blanket may fit within exemplary storage compartment 4.

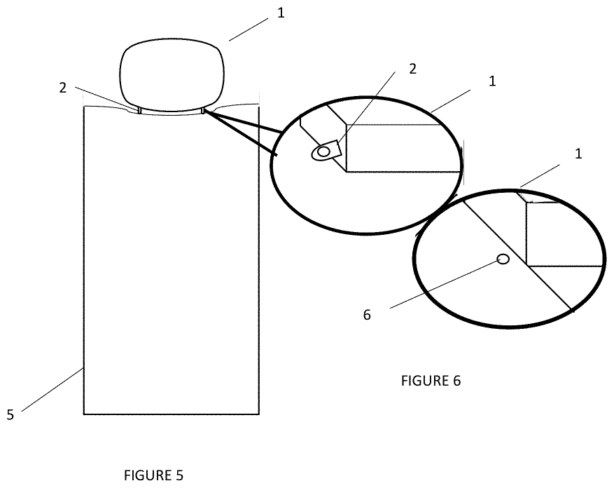

As shown in FIG. 5, which discloses a front view of an exemplary travel apparatus, exemplary blanket 5 may be attached to exemplary pillow 1 by exemplary fasteners 2 of pillow 1 and exemplary fasteners 6 of blanket 5. Pillow 1 and blanket 5 may be removably attached or secured in certain embodiments. Exemplary fasteners 2 and 6 may include Velcro, a button, a snap, straps, fabric sewed to blanket 5 and/or pillow 1, or other suitable means of attaching pillow 1 to blanket 5. Blanket 5 may be comprised of fabric (such as, for example, cotton or polyester), wool, leather, denim, or other suitable material. Exemplary blanket 5 may be the size such that it will substantially cover a person's body while sitting.

In an exemplary embodiment, an exemplary blanket 5 may have dimensions of 60 inches in height and 36 inches in width. Exemplary blanket 5 can have other dimensions, for example, smaller dimension for use, for example, with children, and larger dimensions for use, for example, with larger adults.

As shown in FIG. 6, which discloses a close-up of view of an exemplary fastener of an exemplary travel apparatus, exemplary snap fasteners 2 and 6 may connect to one another to secure pillow 1 to blanket 5.

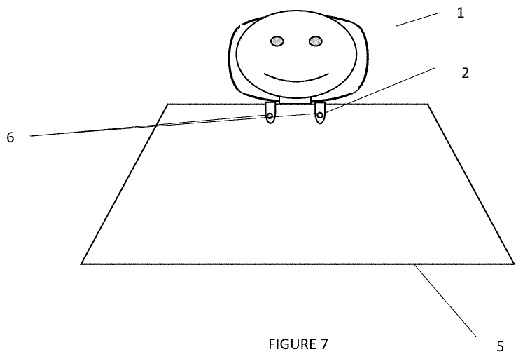

FIG. 7 discloses an exemplary travel apparatus and method in use by a person. As depicted on FIG. 7, blanket 5 is secured to pillow 1 such that when a person sits in the seat the back of the person's head is resting against pillow 1, blanket 5 is supported by pillow 1, and blanket 5 does not cover the face of the person sitting in the seat. In such exemplary travel apparatus and method, additional support is not used to hold blanket 5 in position. Further, blanket 5 is secured in a substantially parallel position relative to the seat's back and the person does not need to use the person's hands or arms to secure the blanket in such substantially parallel position relative to the seat's back, which is in a substantially vertical or upright position.

In an exemplary method, the pillow may be secured to a headrest of a seat by, for example, utilizing fasteners attached to the pillow to secure the pillow to the headrest. In an exemplary travel apparatus and method, pillow 1 is substantially secured in place horizontally by at least one of the fasteners securing the blanket 5 to pillow 1.

In an exemplary method, the blanket may be secured to a pillow through the use of fasteners, which may include Velcro, a button, or a snap.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof.

It is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein is hereby unconditionally reserved. The use of the words “can” and “may” in this document is not an assertion that the subject preceding the word is unimportant or unnecessary or “not critical” relative to anything else in this document. The words “can” and “may” are used herein in a positive and affirming sense and no other motive should be presumed. More than one “invention” may be disclosed in the present disclosure; an “invention” is defined by the content of a patent claim and not by the content of a detailed description of an embodiment of an invention.

What is claimed is:

1. A travel apparatus comprising:
a pillow with a fastener;
a blanket with a fastener; wherein
said blanket is attachable to said pillow by said fasteners; and
said travel apparatus is configured such that when said blanket is attached to said pillow by said fasteners and a person sits in a seat, a back of the person's head is resting against said pillow, said blanket is supported by the pillow, and said blanket does not cover the face of the person sitting in the seat.

2. The travel apparatus of claim 1 wherein at least one of said fasteners attaching said pillow to said blanket is located beside one side of the person's neck and at least one of said fasteners attaching said pillow to said blanket are located beside the opposite side of the person's neck.

3. The travel apparatus of claim 2 wherein said travel apparatus is further configured such that horizontal movement of said pillow is restricted by at least one of said fasteners.

4. The travel apparatus of claim 1 wherein the travel apparatus is configured such no additional support is needed to hold said blanket substantially in place.

5. The travel apparatus of claim 1 wherein the travel apparatus is configured such that the person does not need to use the person's hands or arms to support said pillow or blanket.

6. The travel apparatus of claim 1 wherein the travel apparatus is configured such that, relative to said blanket's area, said blanket substantially covers the front of the person's body below the person's chin.

7. The travel apparatus of claim 1 wherein said travel apparatus is configured such that said pillow is substantially held in place horizontally without the use of the person's hands or arms.

8. The travel apparatus of claim 1 wherein said fastener of said pillow is selected from a group consisting of Velcro, a button, and a snap.

9. The travel apparatus of claim 1 wherein said pillow further comprises a storage compartment configured to store said blanket.

10. The travel apparatus of claim 1 wherein said pillow is horseshoe-shaped.

11. The travel apparatus of claim 1 wherein the seat is a seat of an airplane, train, car, or bus.

12. The travel apparatus of claim 11 wherein the seat is in a substantially upright position.

13. The travel apparatus of claim 12 wherein the travel apparatus is configured such that when a person sits in the seat and a back of the person's head is resting against said pillow, said blanket is secured in a substantially parallel position relative to the seat's back.

14. The travel apparatus of claim 1 wherein said pillow further comprises fasteners configured to attach said pillow to a headrest of the seat.

15. A method comprising:
securing a blanket to a pillow such that when a person sits in a seat a back of the person's head is resting against the pillow, the blanket is supported by the pillow, and the blanket does not cover the face of the person sitting in the seat.

16. The method of claim 15 wherein the blanket is secured to the pillow by fasteners located beside one side of the person's neck and fasteners located beside the opposite side of the person's neck.

17. The method of claim 16 wherein the pillow is substantially secured in place horizontally by at least one of the fasteners securing the blanket to the pillow.

18. The method of claim 17 wherein the seat is in a substantially upright position.

19. The method of claim 18 wherein the blanket is secured in a substantially parallel position relative to the seat's back and the person does not need to use the person's hands or arms to secure the blanket in such substantially parallel position relative to the seat's back.

20. The method of claim 18 wherein the seat is a seat of an airplane, train, car, or bus.
